(19) United States
(12) Patent Application Publication
(10) Pub. No.: US 2007/0184231 A1
(43) Pub. Date: Aug. 9, 2007

(54) Information recording medium

(75) Inventors: Kazuo Kuroda, Saitama (JP); Toshio Suzuki, Saitama (JP); Eiji Muramatsu, Saitama (JP); Masahiro Kato, Saitama (JP); Toshihiko Takishita, Yamanashi (JP); Seiro Oshima, Yamanashi (JP); Atsushi Kondo, Yamanashi (JP)

Correspondence Address: YOUNG & THOMPSON, 745 SOUTH 23RD STREET, 2ND FLOOR, ARLINGTON, VA, 22202, US

(73) Assignee: PIONEER CORPORATION, Tokyo (JP)

(21) Appl. No.: 10/589,672

(22) PCT Filed: Feb. 15, 2005
(86) PCT No.: PCT/JP05/02213

§ 371 Date: Aug. 16, 2006

(30) Foreign Application Priority Data
Feb. 18, 2004 (JP) 2004-041779

(51) Int. Cl. B32B 3/02

(52) U.S. Cl. 428/64.4

(57) ABSTRACT

An information recording medium (100) includes: a first recording layer (107); a semitransparent reflective film (108) to reflect at least one portion of laser light for recording with which the first recording layer is irradiated; a second recording layer (207) which is irradiated with the laser light for recording through the first recording layer and the semitransparent reflective film; and a reflective film (208) to reflect the laser light for recording with which the second recording layer is irradiated, thermal conductivity from the second recording layer to the reflective film when the second recording layer is irradiated with the laser light for recording being substantially equal to thermal conductivity from the first recording layer to the semitransparent reflective film when the first recording layer is irradiated with the laser light for recording

### TECHNICAL FIELD

The present invention relates to an information recording medium, such as a DVD.

### BACKGROUND ART

In an information recording medium, such as a CD-ROM (Compact Disc-Read Only Memory), a CD-R (Compact Disc-Recordable) and a DVD-ROM, for example, as described in patent documents 1 or the like, there is also developed an optical disc of a multilayer type or dual layer type or multiple layer type, in which a plurality of recording layers are laminated or stacked on the same substrate. More specifically, the dual layer type optical disc has a first recording layer (hereinafter referred to as an “L0 layer”, as occasion demands), as the first layer, located on the front (i.e. on the closer side to an optical pickup) as viewed from the irradiation side of the laser light when the recording is performed by an information recording apparatus, and further has a semitransparent reflective film located on the rear of it (i.e. on the farther side from the optical pickup). Moreover, it has a second recording layer (hereinafter referred to as an “L1 layer”, as occasion demands), as the second layer, located on the rear of the semitransparent reflective film via a middle layer, such as an adhesive layer, and further has a reflective film located on the rear of it. In preparing such a multilayer type information recording medium, the L0 layer and the L1 layer are separately formed and pasted in the end, so that it is possible to manufacture the two-layer type optical disc at low cost.

Then, on the information recording apparatus, such as a CD recorder, laser light for recording is focused (or irradiated) on the L0 layer, to thereby record information into the L0 layer in an irreversible change recording method a rewritable method by irreversible change recording heat by heat or the like. Moreover, the laser light is focused on the L1 layer, to thereby record information into the L1 layer in an irreversible change recording method by irreversible change recording heat by heat or the like, or in a rewritable method.
Patent document 1: Japanese Patent Application Laid Open No. 2001-23237

### DISCLOSURE OF INVENTION

### Subject to be Solved by the Invention

In the case of such a dual-layer type information recording medium, however, a bonded surface (jointed surface) between a pigment film (pigmented coat) forming the L0 layer and the semitransparent reflective film, and a bonded surface between a pigment film forming the L1 layer and the reflective film have different sizes, so that thermal conductivity is different at each bonded surface. Namely, the degree of heat-conducting from the pigment film forming the L0 layer to the semitransparent reflective film which is generated by the laser light is different from the degree of the heat-conducting from the pigment film forming the L1 layer to the reflective film. In particular, this problem may occur in manufacturing the dual-layer type optical disc by pasting the layers. Thus, the aspect of thermal diffusion in the recording area on which the laser light is focused varies in each layer, and as a result, there is such a technical problem that the same recording features cannot be obtained in each of the L0 layer and the L1 layer. The fact that each of the L0 layer and the L1 layer has different recording features may cause such a technical problem that it is difficult or substantially impossible to properly record the information into each layer, which is not preferable.

In order to solve the above-mentioned conventional problem, it is therefore an object of the present invention to provide a multilayer type information recording medium on which the information can be properly recorded or reproduced, by providing the equivalent recording features in each recording layer, for example.

### Means for Solving the Subject

In order to solve the above object of the present invention, an information recording medium of the present invention is provided with: a first recording layer; a semitransparent reflective film to reflect at least one portion of laser light for recording with which the first recording layer is irradiated; a second recording layer which is irradiated with the laser light for recording through the first recording layer and the semitransparent reflective film; and a reflective film to reflect the laser light for recording with which the second recording layer is irradiated, thermal conductivity from the second recording layer to the reflective film when the second recording layer is irradiated with the laser light for recording being substantially equal to thermal conductivity from the first recording layer to the semitransparent reflective film when the first recording layer is irradiated with the laser light for recording.

These effects and other advantages of the present invention become more apparent from the following embodiment.

### BRIEF DESCRIPTION OF DRAWINGS

FIG. 1 shows the basic structure of an optical disc in a first example of the information recording medium of the present invention wherein an upper part is a substantial plan view showing the optical disc having a plurality of recording areas, and a corresponding lower part is a schematic conceptual view showing a recording area structure in the radial direction.

FIG. 2 is a partially enlarged perspective view showing the recording surface of the optical disc in the first example of the information recording medium of the present invention.

FIG. 3 is a cross sectional view showing the optical disc in the first example of the information recording medium of the present invention.

FIG. 4 is a cross sectional view showing an optical disc in a comparison example related to the optical disc in the first example of the information recording medium of the present invention.

FIG. 5 is a cross sectional view conceptually showing a method of manufacturing the optical disc in the first example of the information recording medium of the present invention.

FIG. 6 is a cross sectional view showing an optical disc in a second example of the information recording medium of the present invention.

FIG. 7 is a cross sectional view conceptually showing a method of manufacturing the optical disc in the second example of the information recording medium of the present invention.

FIG. 8 is a cross sectional view showing an optical disc in a third example of the information recording medium of the present invention.

FIG. 9 is a cross sectional view conceptually showing a method of manufacturing the optical disc in the third example of the information recording medium of the present invention.

FIG. 10 is a block diagram showing an information recording/reproducing apparatus 300 in an example of the present invention.

### DESCRIPTION OF REFERENCE CODES

1 . . . center hole
100, 100b, 100c . . . optical disc
106 . . . first substrate
107 . . . first recording layer
108 . . . semitransparent reflective film
206 . . . second substrate
206p . . . projection
207 . . . second recording layer
208 . . . reflective film
209 . . . low-heat conductive film
300 . . . information recording/reproducing apparatus
GT . . . groove track
LT . . . land track
LB . . . laser light
LP . . . land pre-pit

### Best Mode for Carrying Out the Invention

An embodiment of the information recording medium of the present invention is provided with: a first recording layer; a semitransparent reflective film to reflect at least one portion of laser light for recording with which the first recording layer is irradiated; a second recording layer which is irradiated with the laser light for recording through the first recording layer and the semitransparent reflective film; and a reflective film to reflect the laser light for recording with which the second recording layer is irradiated, thermal conductivity from the second recording layer to the reflective film when the second recording layer is irradiated with the laser light for recording being substantially equal to thermal conductivity from the first recording layer to the semitransparent reflective film when the first recording layer is irradiated with the laser light for recording.

According to the embodiment of the information recording medium of the present invention, on a dual-layer type or multilayer type information recording medium on which two or more layers including the first and second recording layers are laminated, each of the first and second recording layers is constructed from a recording layer of an irreversible change recording type by heat or the like, such as a pigment film. Alternatively, it may be constructed from a recording layer of a phase change type. Therefore, when information is recorded into the first recording layer on the information recording medium, the laser light for recording is focused on the first recording layer. By this, a record pit or a record mark is recorded into the first recording layer. Moreover, when the information is recorded into the second recording layer on the information recording medium, the laser light for recording is focused on the second recording layer, through the first recording layer and the like. By this, a record pit or a record mark is recorded into the second recording layer. Then, the first and second recording layers are disposed between a first substrate and a second substrate. Namely, it may be constructed such that lamination is formed in the order of the first substrate, the first recording layer, the semitransparent reflective film, the second recording layer, the reflective film, and the second substrate, as viewed from the irradiation side of the laser light.

In the embodiment, there is a small difference (or ideally equal or substantially equal) between the thermal conductivity (or thermal conductivity characteristic) from an area irradiated with the laser light in the first recording layer (i.e. an area where the record pit or the record mark described above is formed) to the semitransparent reflective film and the thermal conductivity from an area irradiated with the laser light in the second recording layer to the reflective film.

For example, the reflective film may be formed to substantially equalize the thermal conductivities. Specifically, the reflective film is formed to substantially equalize the thermal conductivities (e.g., to make the thermal conductivities equivalent or approximate), as compared to the case in which the reflective film is uniformly formed on the entire area of the second recording layer. The expression of “uniformly formed” means that the reflective film is formed by uniformly perform a film formation process for the entire surface of the second recording layer (or the second substrate, for example), as in the case of a traditional manufacturing method, such as the above-mentioned conventional technology, wherein the film formation process is a CVD process or the like in the film formation procedure of the reflective film, for example. Namely, if the entire surface of the second recording layer is a uniform planarized surface without unevenness, the film formation process performed uniformly for the entire surface causes the reflective film with a uniform film thickness to be formed on the second recording layer. If there is unevenness on the surface of the second recording layer, the reflective film whose film thickness changes more or less in accordance with the unevenness is formed on the second recording layer. As described above, the film formation process performed uniformly for the surface of the second recording layer results in the reflective film uniformly formed in the entire area of the second recording layer, as in the case of the traditional manufacturing method, such as the above-mentioned conventional technology. Particularly in the present invention, as compared to the case of “the film formation process performed uniformly”, the reflective film may be formed to reduce the difference between the above-mentioned thermal conductivities. Namely, as compared to the case of “the film formation process performed uniformly”, a process to approximate the thermal conductivity from the first recording layer to the semitransparent reflective film and the thermal conductivity from the second recording layer to the reflective film to each other (or to substantially equalize the thermal conductivity) is performed.

As a predetermined process to substantially equalize the two thermal conductivities as described above, specifically, it may be to reduce the difference between the above-mentioned two thermal conductivities by forming a metal reflective film only in one portion of the second recording layer, as described later, or to substantially equalize the above-mentioned two thermal conductivities by using a low-heat conductive film, or to substantially equalize the above-mentioned two thermal conductivities by properly selecting materials of the first recording layer, the second recording layer, the semitransparent reflective film, and the reflective film or the like.

If the thermal conductivity from the first recording layer to the semitransparent reflective film is relatively greatly different from the thermal conductivity from the second recording layer to the reflective film, then, thermal diffusion progresses relatively quickly (i.e. easy to conduct heat) in one of the recording layers, and thermal diffusion progresses relatively slowly (i.e. difficult to conduct heat) in the other recording layer. This changes the state of the record pit or the record mark recorded by the laser light. This is not preferable from the viewpoint of a stable recording operation, and this has such a technical problem that it may cause an increase in recording errors. However, according to the information recording medium in the embodiment, it is possible to prevent such a disadvantage that the first recording layer and the second recording layer have different recording features, as described above, because the thermal conductivity from the first recording layer to the semitransparent reflective film is substantially equal to the thermal conductivity from the second recording layer to the reflective film. Of course, ideally, the thermal conductivity from the first recording layer to the semitransparent reflective film may be equal to the thermal conductivity from the second recording layer to the reflective film. In other words, even if there is a difference between the two thermal conductivities, it is only necessary to make the difference small enough to make equal or substantially equivalent recording features in the first recording layer and in the second recording layer. By this, in both the first recording layer and the second recording layer, it is possible to obtain the same or substantially the same recording features, and it is possible to realize a stable and proper recording operation.

Consequently, according to the embodiment of the information recording medium of the present invention, it is possible to realize the equivalent recording features in each recording layer, and as a result, it is possible to realize a proper recording operation in each recording layer.

In one aspect of the embodiment of the information recording medium of the present invention, the reflective film is formed in contact with a partial area of the second recording layer.

According to this aspect, by forming the reflective film in contact with a partial area of the second recording layer, it is possible to substantially equalize the thermal conductivity from the first recording layer to the semitransparent reflective film and the thermal conductivity from the second recording layer to the reflective film. Namely, the reflective film is irradiated with the laser light, to thereby conduct (or diffuse) heat, so that it is possible to substantially equalize the thermal conductivity in each recording layer, relatively easily, by properly adjusting the size of the partial area where the reflective film is formed. This uses the fact that the thermal conductivity of a portion where the reflective film including metal is formed is relatively large (i.e. easy to conduct heat) and the thermal conductivity of a portion where the reflective film is not formed is relatively small (i.e. difficult to conduct heat). Incidentally, the “reflective film” in the present invention means a film having high optical reflectance, such as 99%, which is beyond 50% and rather close to 100%, in a surface unit of a film or the like, made of aluminum alloy and having a film thickness of a predetermined value or more. As such a reflective film, existing or known various reflective films can be adopted.

In addition, a conventional structure used for the information recording medium can be adopted as the structure of the first recording layer, so that there is also such an advantage that it is possible to achieve excellent recording features as a result of technical development cumulatively advanced, in the first recording layer.

In another aspect of the embodiment of the information recording medium of the present invention, a portion of the reflective film contacting a partial area of the second recording layer is formed with a first film thickness, and a portion of the reflective film contacting an area other than the partial area of the second recording layer is formed with a second film thickness thinner than the first film thickness.

According to this aspect, as the reflective film is thinner, the thermal conductivity is smaller. For this, it is possible to substantially equalize the thermal conductivity from the first recording layer to the semitransparent reflective film and the thermal conductivity from the second recording layer to the reflective film. Moreover, in manufacturing the information recording medium on which the reflective film is formed in the above-mentioned partial area, the reflective film may attach in a portion other than the partial area, depending on manufacturing conditions or the like. However, if the attaching reflective film is thinner than the reflective film to be originally formed, it is possible to receive the various benefits owned by the information recording medium in the embodiment. Therefore, there is an advantage that it contributes to the improvement of the yield of the information recording medium in the embodiment.

Incidentally, if the reflective film having such a relatively thin film thickness is formed, a first area and a second area described later do not always have the same size, and preferably, it is only necessary that the thermal conductivities are substantially the same in each of the recording layers, in view of the thermal conductivity of the reflective film having the thin film thickness.

In an aspect of the information recording medium on which the reflective film is formed in the partial area as described above, the reflective film is formed such that a first area, which is irradiated with the laser light, out of a bonded surface between the first recording layer and the semitransparent reflective film has a substantially same size as a second area, which is irradiated with the laser light, out of a bonded surface between the second recording layer and the reflective film.

By virtue of such construction, it is possible to substantially equalize the thermal conductivity from the first recording layer to the semitransparent reflective film and the thermal conductivity from the second recording layer to the reflective film, relatively easily. Namely, the heat by the laser light is conducted at the bonded surface between each recording layer and the reflective film or the semitransparent reflective film, so that by equalizing the size of the area irradiated with the laser light out of the bonded surfaces (i.e. the size of each of the first area and the second area), the thermal conductivities thereof can be made closer to each other. Namely, it is possible to reduce a difference between the thermal conductivities. Incidentally, the “same or equal” in the present invention not only indicates a literal meaning of the same or equal size, but also is a wide concept including substantially the same size, more specifically, a size to make the thermal conductivities from the recording layer (the first or second recording layer) to the reflective film (the semitransparent reflective film or the reflective film) closer (or smaller).

Nonetheless, depending on the types of materials of the reflective film itself or the semitransparent reflective film itself, it is possible to reduce the difference between thermal conductivities even if the first area and the second area do not have the same size.

In another aspect of the embodiment of the information recording medium of the present invention, a low-heat conductive film having lower thermal conductivity than the reflective film is formed in at least a partial area between the reflective film and the second recording layer.

According to this aspect, the heat by the laser light is not easily conducted at a portion where the low-heat conductive film is formed, so that it is possible to create the same situation as the above-mentioned aspect in which the reflective film is not formed. Therefore, by forming the low-heat conductive film in a portion where it is desired to lower the thermal conductivity, it is possible to substantially equalize the thermal conductivity from the first recording layer to the semitransparent reflective film and the thermal conductivity from the second recording layer to the reflective film, relatively easily.

Incidentally, any material whose thermal conductivity is lower than that of the reflective film can be used as the low-heat conductive film. Moreover, depending on the thermal conductivity of the low-heat conductive film, the low-heat conductive film may be formed in the partial area between the reflective film and the second recording layer, or may be formed in the entire surface. Alternatively, if the lo-heat conductive film is formed in the partial area between the reflective film and the second recording layer, it is preferable to properly adjust the size (or range) of the low-heat conductive film to be formed, depending on the thermal conductivity of the low-heat conductive film. In any cases, it is preferable to form the low-heat conductive film to reduce the difference between the thermal conductivity from the first recording layer to the semitransparent reflective film and the thermal conductivity from the second recording layer to the reflective film

These effects and other advantages of the present invention become more apparent from the following examples.

As explained above, according to the embodiment of the information recording medium of the present invention, the thermal conductivity of the heat, generated by the irradiation of the laser light, conducting from the second recording layer to the reflective film is substantially equal to the thermal conductivity of the heat conducting from the first recording layer to the semitransparent reflective film. Therefore, it is possible to realize the equivalent recording features in each recording layer, and as a result, it is possible to realize a proper recording operation in each recording layer.

### EXAMPLES

(Information Recording Medium)

Hereinafter, the examples of the information recording medium of the present invention will be discussed with reference to the drawings.

### First Example

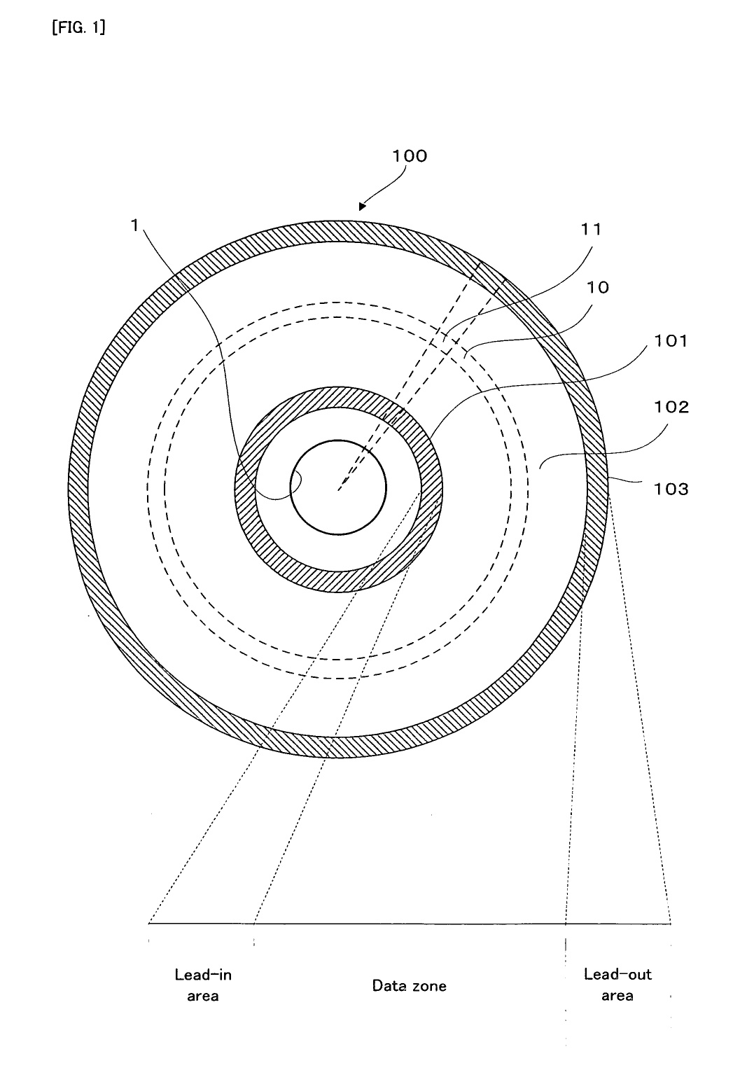

With reference to FIG. 1 to FIG. 5, an optical disc in the first example of the information recording medium of the present invention will be discussed in detail.

At first, with reference to FIG. 1, the basic structure of the optical disc in the first example will be discussed. FIG. 1 shows the basic structure of an optical disc in a first example of the information recording medium of the present invention wherein an upper part is a substantial plan view showing the optical disc having a plurality of recording areas, and a corresponding lower part is a schematic conceptual view showing a recording area structure in the radial direction.

As shown in FIG. 1, an optical disc 100 has a recording surface on a disc main body with a diameter of about 12 cm, as is a DVD. On the recording surface, the optical disc 100 is provided with: a lead-in area 101; a data zone 102; and a lead-out area 103, from the inner to the outer circumferential side, with a center hole 1 as the center. Then, in each recording area, a track or tracks 10, such as a groove track and a land track, are alternately placed, spirally or concentrically, with the center hole 1 as the center. On the track 10, data is divided and recorded by a unit of sector 11. The sector 11 is a data management unit by a pre-format address in which record information is error-correctable.

Incidentally, the present invention is not particularly limited to the optical disc having these three areas. For example, even if the lead-in area 101 or the lead-out area 103 does not exist, a data structure explained below can be constructed. Moreover, as described later, the lead-in area 101 or the lead-out area 103 may be further segmentized.

As shown in FIG. 2, the optical disc 100 in the first example is constructed as a dual-layer type optical disc on which a plurality of data zones 102 or the like are formed in a lamination structure, for example. FIG. 2 is a partially enlarged perspective view showing the recording surface of the optical disc in the first example.

In FIG. 2, in the first example, the optical disc 100 has a first recording layer 107 of an irreversible change recording type by heat or the like, which constitutes an information recording surface, laminated on (on the lower side of, in FIG. 2) a disc-shaped transparent substrate 106. The optical disc 100 further has a semitransparent reflective film 108 on the first recording layer 107 (on the lower side thereof in FIG. 2). On the information recording surface constructed from the surface of the first recording layer 107, the groove track GT and the land track LT are alternately formed. Incidentally, upon recording and reproduction of the optical disc 100, for example, as shown in FIG. 2, the groove track GT is irradiated with laser light LB through the transparent substrate 106. For example, upon recording, the laser light LB is irradiated with a recording laser power, to thereby perform the irreversible change recording by heat or the like, with respect to the first recording layer 107, in accordance with the record data. On the other hand, upon reproduction, the laser light LB is irradiated with a reproduction laser power weaker than the recording laser power, by which the record data recorded in the first recording layer 107 is read.

In the first example, the groove track GT is oscillated with a constant amplitude and at a constant spatial frequency. In other words, the groove track GT is wobbled, and the cycle of the wobble 109 is set to a predetermined value. On the land track LT, there is formed an address pit which is referred to as a land pre-pit LP and which indicates pre-format address information. By virtue of the two addressing (i.e. the wobble 109 and the land pre-pit LP), it is possible to obtain information, such as a recording address or the like, necessary for disc rotation control during the recording, generation of a recording clock or data recording. Incidentally, it is also possible to record the pre-format address in advance, by modulating the wobble 109 of the groove track GT in a predetermined modulation method, such as frequency modulation and phase modulation.

Moreover, in the first example, a second recording layer 207 (i.e. the L1 layer) is formed on (on the lower side of, in FIG. 2) the semitransparent reflective film 108. A reflective film 208 is formed on (on the lower side thereof, in FIG. 2) the second recording layer 207. The second recording layer 207 is constructed such that the recording and reproduction of the irreversible change recording type by heat or the like can be performed in substantially the same manner as the first recording layer 107, by irradiating the laser light LB through the transparent substrate 106, the first recording layer 107, and the semitransparent reflective film 108. With regard to the second recording layer 207 and the reflective film 208, they may be film-formed on the transparent substrate 106 on which the first recording layer 107 and the semitransparent reflective film 108 or the like are formed. Alternatively, after each of them is film-formed on a different substrate, they may be pasted to the transparent substrate 106. Incidentally, between the semitransparent reflective film 108 and the second recording layer 207, there is provided a transparent middle layer 205 constructed from a transparent adhesive or the like, as occasion demands, according to the manufacturing method.

Upon the recording and reproduction of such a dual-layer type optical disc 100, the recording and reproduction in the first recording layer 107 or the second recording layer 207 is performed, depending on which recording layer has the focus position of the laser light LB.

Incidentally, the optical disc 100 in the first example is not limited to a dual-layer single sided type, i.e., a dual layer type, but may be an optical disc of a multilayer type which has three or more layers. In the case of the optical disc having three or more layers, a semitransparent reflective film may be provided instead of the reflective film 208, and further, a third recording layer and a reflective film (or a semitransparent reflective film) may be sequentially formed thereon (on the lower side of, in FIG. 2).

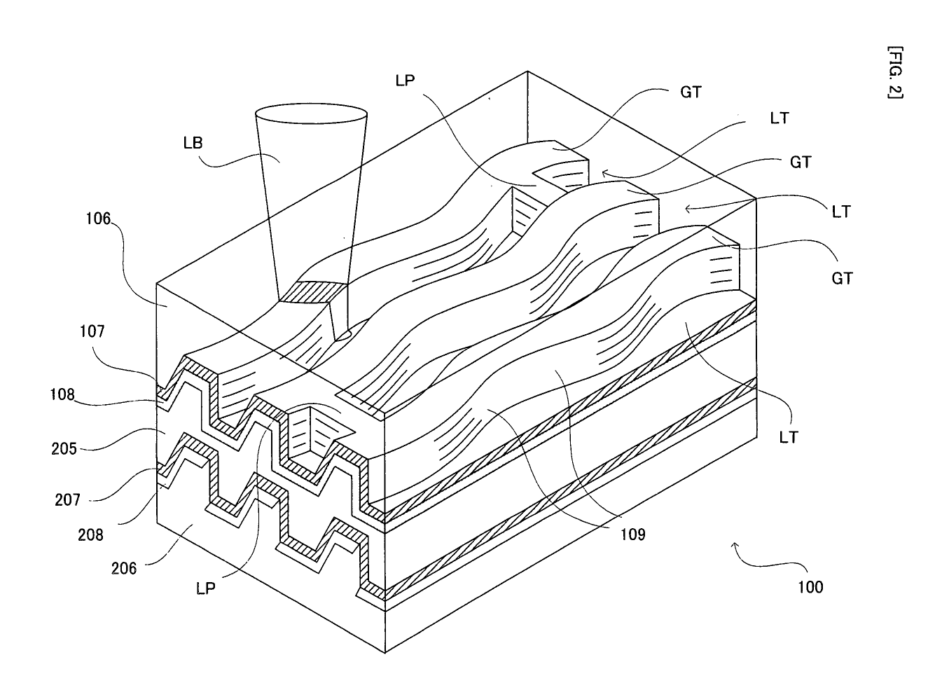

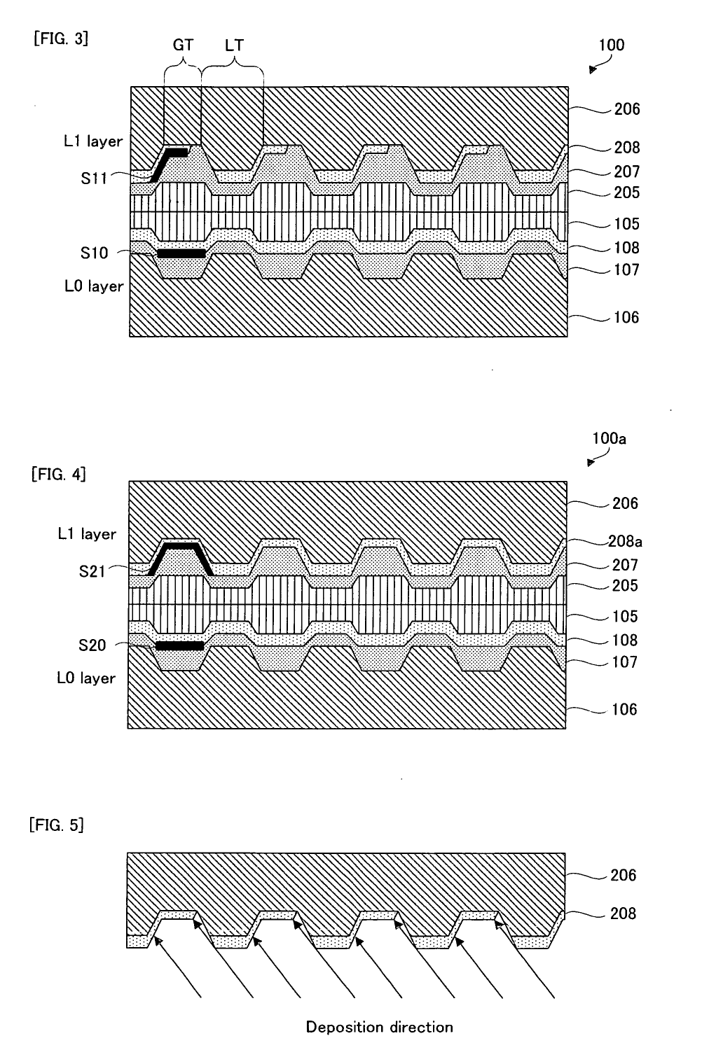

The lamination structure of the optical disc 100 will be explained in detail, with reference to FIG. 3. FIG. 3 is a cross sectional view showing the optical disc in the first example.

As shown in FIG. 3, in the optical disc 100, the L0 layer is formed from the transparent substrate 106, the first recording layer 107 and the semitransparent reflective film 108. The L1 layer is formed from the second recording layer 207, the reflective film 208 and a substrate 206. Then, the semitransparent reflective film 108 and the second recording layer 207 are pasted by the transparent middle layer 205 (105), constructed from a transparent adhesive or the like, to thereby form the dual-layer type optical disc 100.

Particularly in the first example, the reflective film 208 is formed only in a partial area on the second recording layer 207 (i.e. between the second recording layer 207 and the substrate 206). The reflective film 208 is not formed in the other area on the second recording layer 207. More specifically, the reflective film is formed in the land track LT, either of the wall surfaces of the groove track GT and one portion of the bottom surface of the groove track GT. The reflective film 208 is not formed in other of the wall surfaces of the groove track GT and another portion of the bottom surface of the groove track GT. Therefore, the laser light LB is reflected in a portion where the reflective film 208 is formed. The laser light LB is not reflected in a portion where the reflective film 208 is not formed, for example, it is absorbed or scattered at the substrate 206.

Explaining one example of the specific film thickness of the layers, the film thickness of the reflective film 208 is approximately 50 nm, the depth of the groove of the groove track is approximately 180 nm, a distance from a boundary between the middle layer 105 and the middle layer 205 to the land track LT is preferably approximately 200 nm. However, the film thickness is not limited to the above-mentioned values. It may be in a range of values which are applied to a general optical disc, or may be in a range of values which allow proper data recording into each of the L0 layer and the L1 layer.

As described above, by forming the reflective film 208 in one portion of the second recording layer, it is possible to equalize the size (i.e. areal size) of a bonded surface S11 between the reflective film 208 and the second recording layer 207 and the size of a bonded surface S10 between the semitransparent reflective film 108 and the first recording layer 107. As a result, it is possible to make the substantially equivalent degree of heat-diffusing (or conducting), by the irradiated laser light LB, from the recording layer portion (i.e. the first recording layer 107 or the second recording layer 207) to the metal portion (i.e. the reflective film 208 or the semitransparent reflective film 108), in the L0 layer and the L1 layer. In other words, it is possible to make the difference between the thermal conductivity from the first recording layer 107 to the semitransparent reflective film 108 and the thermal conductivity from the second recording layer 207 to the reflective film 208 smaller (or ideally equal or substantially equal).

Now as a comparison example of the optical disc 100, an explanation is given with reference to FIG. 4. FIG. 4 is a cross sectional view showing an optical disc in the comparison example.

As shown in FIG. 4, an optical disc 100a in the comparison example is formed from the L0 layer and the L1 layer, as in the optical disc 100 in the first example. In the optical disc 100a in the comparison example, particularly, a reflective film 208a is uniformly formed in the entire area on the second recording layer. As a result, a bonded surface S21 between the reflective film 208a and the second recording layer 207 is larger than a bonded surface S20 between the semitransparent reflective film 108 and the first recording layer 107. Thus, there is such a characteristic that the heat by the irradiated laser light LB is more easily conducted from the second recording layer 207 to the reflective film 208 at the bonded surface S21, than from the first recording layer 107 to the semitransparent reflective film 108 at the bonded surface S20. Therefore, features when the data is recorded at the bonded surface S21 and features when the data is recorded at the bonded surface S20 are different from each other, which causes such a technical problem that good recording features cannot be obtained in the case in which the same laser light LB is used.

However, according to the optical disc 100 in the first example, the bonded surface S11 and the bonded surface S10 have the same size, so that it is possible to make the equivalent degree of thermal conductivity from the recording layer portion to the metal portion, at each of the bonded surfaces. Thus, it is possible to solve the problem such that good recording features cannot be obtained, which is seen in the optical disc 100a in the comparison example. By this, there are such great advantages that it is possible to obtain good recording features in both the L0 layer and the L1 layer, and that it is possible to properly record the data in each recording layer. Consequently, even upon the reproduction of the recorded data, there is such a great advantage that the data can be properly reproduced, to thereby reduce a reproduction error rate.

A method of manufacturing the optical disc 100 will be explained with reference to FIG. 5. FIG. 5 is a cross sectional view conceptually showing a partial procedure in the method of manufacturing the optical disc in the first example.

The optical disc 100 in the first example is manufactured by separately preparing the L0 layer and the L1 layer and pasting them by the middle layer 105 (205) including a transparent adhesive or the like in the end, for example. In the L0 layer, a groove corresponding to the groove track GT is formed on the substrate 106 by using a stampa or the like, and the first recording layer is formed by applying a pigment film thereon using spin coating method or the like, for example. Then, the semitransparent reflective film 108 is formed by metal deposition method. On the other hand, in the L1 layer, a groove corresponding to the groove track GT is formed on the substrate 206, and the reflective film 208 is formed thereon by metal deposition method.

At this time, as shown in FIG. 5, by depositing gas molecules, which are the raw materials of the reflective film 208, from a diagonal direction with respect to the normal line of the bottom surface of the groove track GT of the substrate 206, the land track LT functions as a mask with respect to the gas molecules. As a result, it is possible to form the reflective film 208 only in one portion of the substrate 206. In other words, because the land track LT functions as the mask, the gas molecules of the reflective film 208 are deposited from a direction of forming the reflective film 208 at a desired portion (i.e. a portion where the reflective film 208 is originally formed). Namely, the land track can be used as masking, so that it is unnecessary to provide a special process in order to form the reflective film 208, and it is possible to form the reflective film 208, relatively easily. Incidentally, a masking pattern may be used to deposit the reflective film 208. Chemical processing such as etching may be performed, to thereby form the reflective film 208 by patterning. Mechanical processing such as grinding or polishing may be performed, to thereby form the reflective film 208 by patterning.

Then, after each of the L0 layer and the L1 layer is formed, the semitransparent reflective film 108 and the second recording layer 207 are pasted by the middle layer 105 (205) including a transparent adhesive or the like, to thereby manufacture the optical disc 100.

Incidentally, in the portion where the reflective film 208 is not formed, a reflective film may be formed which is relatively thinner than the portion where the reflective film 208 is to be formed. As it is relatively thinner, it is more difficult to conduct heat. Thus, it is possible to obtain the equivalent effect as in the case where the reflective film 208 is not formed. Moreover, the bonded surfaces S11 and S10 do not always have the same size, and it is only necessary to have a relationship in size which realizes that substantially equivalent recording features (or thermal conductivity characteristic) can be obtained in each of the L0 layer and the L1 layer.

Moreover, even in the case of the optical disc having three or more recording layers, it is possible to substantially equalize the recording features in each recording layer, by substantially equalizing the size of the bonded surface between the metal (i.e. the reflective film and the semitransparent reflective film) and the recording layer, in each recording layer. In other words, the reflective film and the semitransparent reflective film are formed so as to substantially equalize the recording features in each recording layer. As a result, it is possible to receive the same benefits as those of the optical disc 100 in the first example described above.

Consequently, according to the optical disc 100 in the first example, it is possible to make the thermal conductivity characteristic substantially equivalent in the L0 layer and the L1 layer, by substantially equalizing the size of the bonded surface in the L0 layer and the size of the bonded surface in the L1 layer. As a result, it is possible to substantially equalize the recording features in each recording layer, and it is possible to properly record the data. Moreover, it is possible to properly reproduce the recorded data.

### Second Example

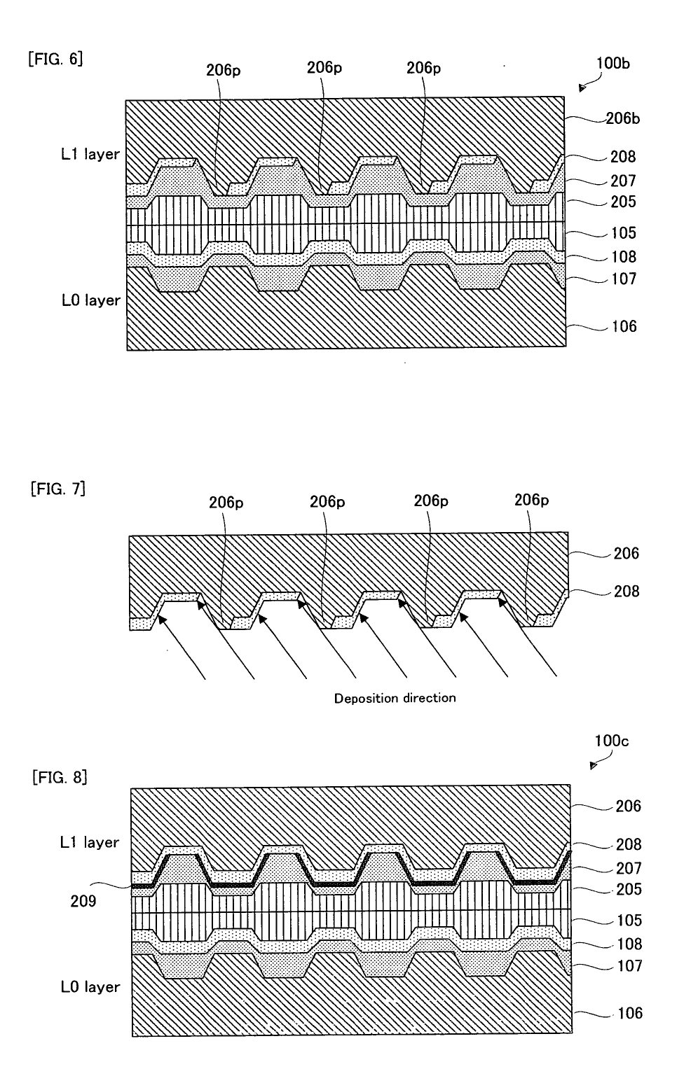

Next, with reference to FIG. 6 and FIG. 7, an optical disc in the second example of the information recording medium of the present invention will be discussed in detail. FIG. 6 is a cross sectional view showing an optical disc in the second example. FIG. 7 is a cross sectional view conceptually showing a partial procedure in the method of manufacturing the optical disc in the second example. Incidentally, the same constitutional elements as those of the optical disc in the first example described above carry the same numerical references, and the detailed explanation thereof is omitted.

As shown in FIG. 6, in an optical disc 100b in the second example, as in the optical disc 100 in the first example, the L0 layer is formed from the transparent substrate 106, the first recording layer 107 and the semitransparent reflective film 108, and the L1 layer is formed from the second recording layer 207, the reflective film 208 and the substrate 206. Then, the semitransparent reflective film 108 and the second recording layer 207 are pasted by the transparent middle layer 205 (105), constructed from a transparent adhesive or the like, to thereby form the two-layer type optical disc 100.

Particularly in the second example, the substrate 206 has such a shape that a projection 206p is further formed in one portion of the land track LT of the L1 layer. Since the substrate 206 has such a shape, it is possible to make the deposition direction (i.e. an angle with respect to the above-mentioned normal line) less sharp, or to adjust a range of depositing the reflective film 208, in the deposition of the reflective film 208 explained in FIG. 5.

Specifically, as shown in FIG. 7, the projection 206p formed on the land track LT works as a barrier for the material gas deposited from the diagonal direction with respect to the substrate 206, so that it is possible to prevent the reflective film 208 from forming on one portion of the groove track GT. The projection 206p may be formed having a proper size and a shape or the like, in accordance with the size (or range or the like) of an area where it is desired to form the reflective film 208. Moreover, the projection 206p may be formed having a proper size and a shape or the like, in accordance with the direction of depositing the reflective film 208 (or direction of depositing the gas molecules).

Consequently, according to the optical disc in the second example, it is possible to receive the same benefits as those of the optical disc in the first example described above, and it is possible to form the reflective film 208, relatively easily.

### Third Example

Next, with reference to FIG. 8 and FIG. 9, an optical disc in the third example of the information recording medium of the present invention will be discussed in detail. FIG. 8 is a cross sectional view showing an optical disc in the third example. FIG. 9 is a cross sectional view conceptually showing a partial procedure in the method of manufacturing the optical disc in the third example. Incidentally, the same constitutional elements as those of the optical disc in the first and second examples described above carry the same numerical references, and the detailed explanation thereof is omitted.

As shown in FIG. 8, in an optical disc 100c in the third example, as in the optical disc 100 in the first example, the L0 layer is formed from the transparent substrate 106, the first recording layer 107, and the semitransparent reflective film 108, and the L1 layer is formed from the second recording layer 207, the reflective film 208, and the substrate 206. Then, the semitransparent reflective film 108 and the second recording layer 207 are pasted by the transparent middle layer 205 (10), constructed from a transparent adhesive or the like, to thereby form the two-layer type optical disc 100.

Particularly, in the optical disc 100c in the third example, a low-heat conductive film 209 is formed between the second recording layer 207 and the reflective film 208. The low-heat conductive film 209 can be formed by deposition, with the land track LT as a barrier, as shown in FIG. 9. The low-heat conductive film 209 includes a material whose thermal conductivity is lower than that of the reflective film 208, so that the thermal conductivity as a whole is lower than that of the reflective film 208. Thus, at the bonded surface where the low-heat conductive film 209 is formed, it is relatively difficult to conduct the heat by the irradiated laser light LB from the second recording layer 207 to the low-heat conductive film 209, and as a result, it is possible to make the thermal conductivity smaller (i.e. make it difficult to diffuse the heat) at the bonded surface between the reflective film 208 and the second recording layer 207. By this, even if the bonded surface between the reflective film 208 and the second recording layer 207 is larger than the bonded surface between the semitransparent reflective film 108 and the first recording layer 107, it is possible to substantially equalize the degree of the heat-conducting from the recording layer portion to the metal portion, at each of the bonded surfaces.

Incidentally, it is preferable to properly adjust the size of an area where the low-heat conductive film 209 is formed, in accordance with the size of the bonded surface in the L0 layer and the size of the bonded surface in the L1 layer. For example, if there is a relatively large difference in size between the bonded surface in the L0 layer and the bonded surface in the L1 layer, the low-heat conductive film 209 is preferably formed in a larger area. On the other hand, if there is a relatively small difference in size between the bonded surface in the L0 layer and the bonded surface in the L1 layer, the low-heat conductive film 209 is preferably formed in a narrower area.

Consequently, according to the optical disc in the third example, it is possible to make the thermal conductivities substantially equivalent in the L0 layer and the L1 layer, by providing the low-heat conductive film 209. As a result, it is possible to receive the same benefits as those of the optical disc in the first example described above.

(Information Recording/Reproducing Apparatus)

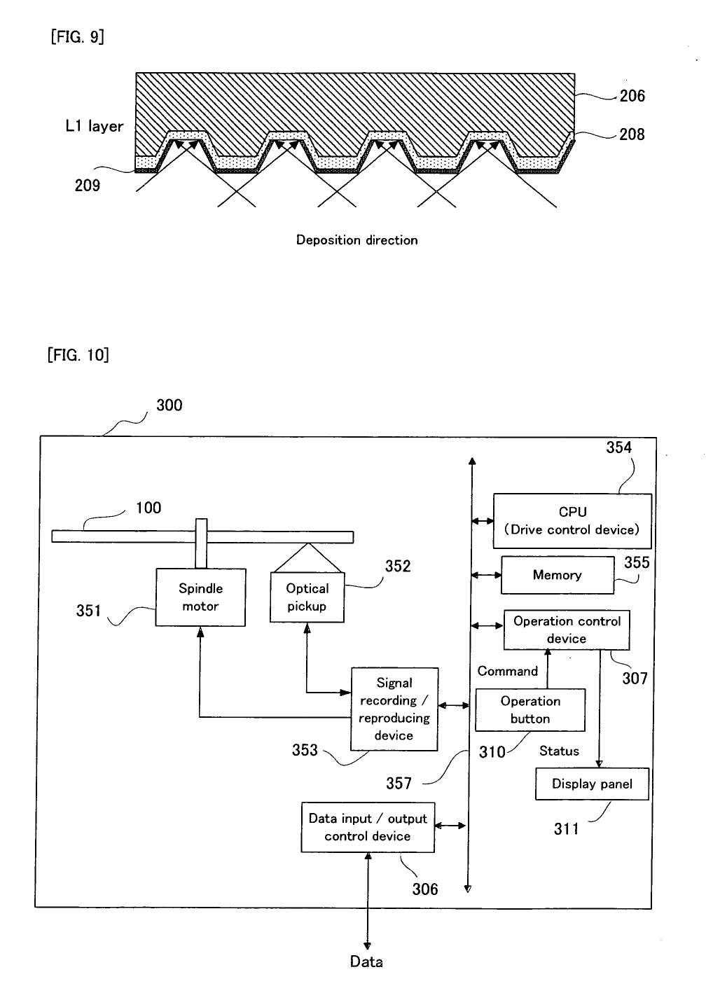

Next, with reference to FIG. 10, an explanation will be given for the structure and the operation of an example of an information recording/reproducing apparatus for recording or reproducing the data by using the information recording medium of the present invention.

At first, with reference to FIG. 10, the structure of an information recording/reproducing apparatus 300 in the example of the present invention will be explained. FIG. 10 is a block diagram showing the information recording/reproducing apparatus 300 in the example of the present invention. Incidentally, the information recording/reproducing apparatus 300 has a function of recording the record data onto the optical disc 100 and a function of reproducing the record data recorded on the optical disc 100.

With reference to FIG. 10, the inner structure of the information recording/reproducing apparatus 300 will be discussed. The information recording/reproducing apparatus 300 is an apparatus for recording the information onto the optical disc 100 and reading the information recorded on the optical disc 100, under the control of a CPU 354.

The information recording/reproducing apparatus 300 is provided with: the optical disc 100; a spindle motor 351; an optical pickup 352; a signal recording/reproducing device 353; the CPU (drive control device) 354; a memory 355; a data input/output control device 306; an operation button 310; a display panel 311; and a bus 357.

The spindle motor 351 is intended to rotate and stop the optical disc 100, and operates upon accessing the optical disc. More specifically, the spindle motor 351 is constructed to rotate and stop the optical disc 100 at a predetermined speed, under spindle servo from a not-illustrated servo unit or the like.

The optical pickup 352 is to perform the recording/reproduction with respect to the optical disc 100, and is provided with a laser device, a lens, and the like. More specifically, the optical pickup 352 irradiates the optical disc 100 with a light beam, such as a laser beam, as reading light with a first power upon reproduction, and as writing light with a second power upon recording, with it modulated.

The signal recording/reproducing device 353 controls the spindle motor 351 and the optical pickup 352, to thereby perform the recording/reproduction with respect to the optical disc 100.

The memory 355 is used in the whole data processing and the OPC process or the like on the disc drive 300, including a buffer area for the record/reproduction data, an area used as an intermediate buffer when data is converted into the data that can be used on the signal recording/reproducing device 353, and the like. Moreover, the memory 355 is provided with: a ROM area into which a program for performing an operation as a recording device is stored; a buffer used for compression/decompression of video data; a RAM area into which a parameter required for the operation of a program or the like is stored; and the like.

The CPU (drive control device) 354 is connected to the signal recording/reproducing device 353 and the memory 355 through the bus 357, and controls the entire information recording/reproducing apparatus 300 by giving an instruction to various controlling devices. Normally, software or firmware for operating the CPU 354 is stored in the memory 355.

The data input/output control device 306 controls the input/output of the data from the exterior with respect to the information recording/reproducing apparatus 300, to thereby perform storage to and export from the data buffer on the memory 355. If the input/output of the data is a video signal, when the data is inputted, the data received from the exterior is compressed (encoded) in a MPEG format and outputted to the memory 355. When the data is outputted, the data in the MPEG format received from the memory 355 is decompressed (decoded) and outputted to the exterior.

An operation control device 307 receives an operation instruction and performs display with respect to the information recording/reproducing apparatus 300, and transmits an instruction by the operation button 310, such as an instruction to record or reproduce, to the CPU 354. The operation control device 307 outputs the operational state of the information recording/reproducing apparatus 300, such as during recording and during reproduction, to the display panel 311, such as a fluorescent tube and an LCD.

Household equipment as one specific example of the information recording/reproducing apparatus 300 explained above, is recorder equipment for recording and reproducing video images. The recorder equipment records a video signal from a broadcast reception tuner and an external connection terminal, onto a disc, and outputs the video signal reproduced from the disc to external display equipment, such as a television. The operation as the recorder equipment is performed by executing a program stored in the memory 355, on the CPU 354.

Particularly in the example, the optical disc 100 is the above-mentioned dual-layer type optical disc, and the first recording layer 107 and the second recording layer 207 have the same thermal conductivities. Thus, the recording and reproduction in the first recording layer 107 and the recording and reproduction in the second recording layer 207 can be both performed well, by the optical pickup 352 by using the laser light with an appropriate power. Moreover, it has such advantages that it is possible to equalize the recording features of the information recorded in each layer, and that it is possible to improve the recording quality and the reproduction quality thereof.

The present invention is not limited to the above-described examples, and various changes may be made, if desired, without departing from the essence or spirit of the invention which can be read from the claims and the entire specification. An information recording medium and a manufacturing method thereof, all of which involve such changes, are also intended to be within the technical scope of the present invention.

### INDUSTRIAL APPLICABILITY

The information recording medium of the present invention can be applied to a multilayer type information recording medium or the like on which information can be properly recorded or reproduced, such as an optical disc of a multilayer type or double layer type or multiple layer type in which a plurality of recording layers are laminated on the same substrate, for example.

1. An information recording medium comprising:
a first recording layer;
a semitransparent reflective film to reflect at least one portion of laser light for recording with which said first recording layer is irradiated;
a second recording layer which is irradiated with the laser light for recording through said first recording layer and said semitransparent reflective film; and
a reflective film to reflect the laser light for recording with which said second recording layer is irradiated,
thermal conductivity from said second recording layer to said reflective film when said second recording layer is irradiated with the laser light for recording being substantially equal to thermal conductivity from said first recording layer to said semitransparent reflective film when said first recording layer is irradiated with the laser light for recording.

2. The information recording medium according to claim 1, wherein said reflective film is formed in contact with a partial area of said second recording layer.

3. The information recording medium according to claim 1, wherein a portion of said reflective film contacting a partial area of said second recording layer is formed with a first film thickness, and a portion of said reflective film contacting an area other than the partial area of said second recording layer is formed with a second film thickness thinner than the first film thickness.

4. The information recording medium according to claim 2, wherein said reflective film is formed such that a first area, which is irradiated with the laser light, out of a bonded surface between said first recording layer and said semitransparent reflective film has a substantially same size as a second area, which is irradiated with the laser light, out of a bonded surface between said second recording layer and said reflective film

5. The information recording medium according to claim 1, wherein a low-heat conductive film having lower thermal conductivity than said reflective film is formed in at least a partial area between said reflective film and said second recording layer.
